(19) United States
(12) Patent Application Publication
(10) Pub. No.: US 2016/0132993 A1
(43) Pub. Date: May 12, 2016

(54) SCREEN CONTROL METHOD AND COMMUNICATION DEVICE

(71) Applicant: FUJITSU LIMITED, Kawasaki-shi (JP)

(72) Inventor: Katsuhiko AKIYAMA, Kawasaki (JP)

(73) Assignee: FUJITSU LIMITED, Kawasaki-shi (JP)

(21) Appl. No.: 14/855,663

(22) Filed: Sep. 16, 2015

(30) Foreign Application Priority Data
Nov. 6, 2014 (JP) 2014-226444

(51) Int. Cl. G06T 3/60; G06T 7/00; G06F 3/01; G06K 9/00

(52) U.S. Cl. CPC G06T 3/60; G06K 9/00248; G06T 7/0042; G06F 3/017; G06T 2207/10004; G06T 2207/30201

(57) ABSTRACT

A screen control method executed by a computer includes: acquiring an image; executing recognition processing to specify a first direction from a top of a head to a chin in a face region of a user extracted from the image when the face region is detected; when the first direction is not specified in the recognition processing, determining a second direction based on given operation by the user; and setting a display direction of a screen displayed on a display based on the second direction.

### CROSS-REFERENCE TO RELATED APPLICATION

This application is based upon and claims the benefit of priority of the prior Japanese Patent Application No. 2014-226444, filed on Nov. 6, 2014, the entire contents of which are incorporated herein by reference.

### FIELD

The embodiments discussed herein are related to a communication device and a screen control method.

### BACKGROUND

For example, communication devices such as mobile phones, personal digital assistants (PDAs), and smartphones frequently have e.g. a vertically-long rectangular flat plate shape in terms of easiness of grasp and easiness of use. Therefore, display screens of the communication devices are also made to specifications based on vertically-long screens and software incorporated in the communication devices is also designed to specifications based on the vertically-long screen. However, in recent years, also for the communication devices, consideration on specifications based on horizontally-long screens is being promoted so that moving images and horizontally-long websites for personal computers can be viewed for example.

Thus, for example, in an operating system (OS) for smartphones, a technique that allows switching between a vertically-long screen (portrait) mode and a horizontally-long screen (landscape) mode according to given operation is known. Moreover, a technique that displays a QWERTY keyboard slidably and drawably on a display screen and allows switching from a vertical screen to a horizontal screen is also known.

Furthermore, the following technique is also known in a communication device. For example, the communication device includes a built-in acceleration sensor and has a mechanism to make switching to a vertical screen and a horizontal screen according to the tilt direction. When a user grasps the device main body longitudinally, the display screen is displayed as the vertical screen. When the user grasps the device main body laterally, the display screen is displayed as the horizontal screen.

However, although the screen direction of the display screen is changed according to the detection result of the acceleration sensor in the communication device, there is a possibility that the display screen is set in a screen direction that is not intended by the user when the posture of the user who grasps the device main body is lying on the back or on a side for example. Thus, the following system is known in a communication device. For example, the frontal face of a user is imaged by a camera provided on the same surface as a display screen. Then, the face direction of the user is recognized from the taken image and the screen direction of the display screen is set to the recognized face direction. The user can suppress setting to an unintended screen direction.

Related arts are disclosed in Japanese Laid-open Patent Publication No. 2007-17596, Japanese Laid-open Patent Publication No. 2008-177819, Japanese Laid-open Patent Publication No. 2009-130816, Japanese Laid-open Patent Publication No. 2013-150129, Japanese Laid-open Patent Publication No. 2011-138449, and Japanese Laid-open Patent Publication No. 2009-163659 for example.

### SUMMARY

According to an aspect of the invention, a screen control method executed by a computer includes: acquiring an image; executing recognition processing to specify a first direction from a top of a head to a chin in a face region of a user extracted from the image when the face region is detected; when the first direction is not specified in the recognition processing, determining a second direction based on given operation by the user; and setting a display direction of a screen displayed on a display based on the second direction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating one example of a communication device of a first embodiment;

FIG. 2 is a front view of a communication device;

FIGS. 3A and 3B are explanatory diagrams illustrating one example of an operation of a communication device when a face direction of a user is recognized;

FIGS. 4A, 4B, 4C, and 4D are explanatory diagrams illustrating one example of an operation of a communication device when face direction recognition has failed;

FIG. 5 is a flowchart illustrating one example of a processing operation of a processor relating to screen control processing;

FIG. 6 is a block diagram illustrating one example of a communication device of a second embodiment;

FIGS. 7A, 7B, and 7C are explanatory diagrams illustrating one example of a specifying operation to specify an indication direction from a tilt direction;

FIG. 8 is a block diagram illustrating one example of a communication device of a third embodiment;

FIG. 9 is an explanatory diagram illustrating one example of a specifying operation to specify an indication direction from a swing direction;

FIGS. 10A, 10B, 10C, and 10D are explanatory diagrams illustrating one example of an estimated grasp position; and

FIG. 11 is an explanatory diagram illustrating one example of a communication device that executes screen control programs.

### DESCRIPTION OF EMBODIMENTS

In the communication device, in recognition of the face direction of a user from a taken image, it is difficult to recognize the face direction of the user if a feature part of the face of the user does not exist in the taken image. For example, it is difficult to recognize the face direction of the user from the taken image when the face of the user does not fall within the frame of the camera or when the vicinity of the lens of the camera is hidden by a finger or when the imaging is performed under a bad condition such as backlight or a dark place. As a result, the display screen is set in a screen direction that is not intended by the user.

In one aspect, the embodiments discussed herein aim at setting the display screen in a screen direction intended by a user.

Embodiments of a communication device, a screen control method, and a screen control program disclosed by the present application will be described in detail below on the basis of the drawings. Disclosed techniques are not limited by the embodiments. Furthermore, the respective embodiments to be illustrated below may be combined as appropriate within a range in which contradiction is not caused.

### First Embodiment

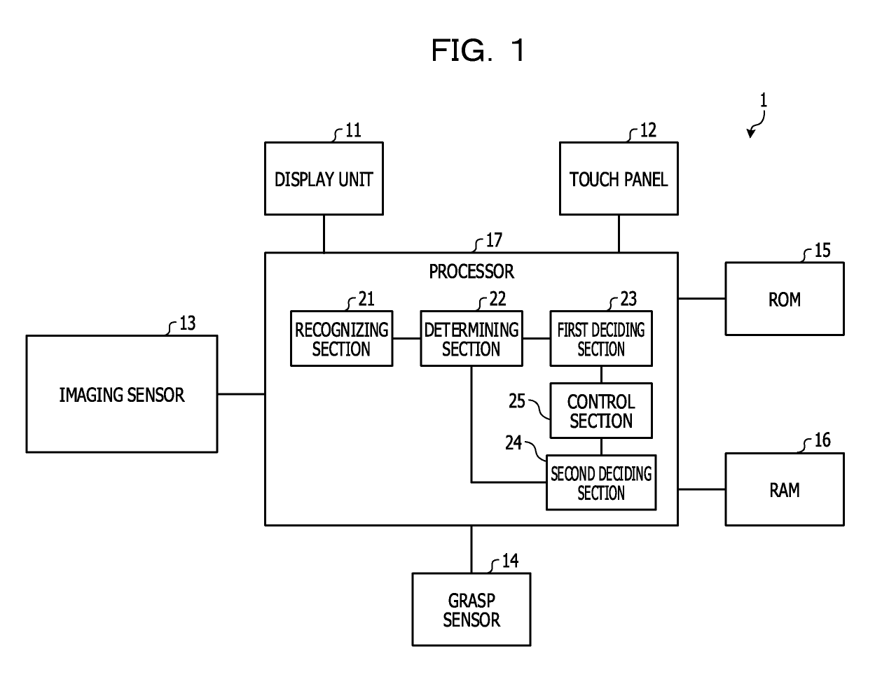

FIG. 1 is a block diagram illustrating one example of a communication device of a first embodiment. A communication device 1 illustrated in FIG. 1 includes a display unit 11, a touch panel 12, an imaging sensor 13, a grasp sensor 14, a read only memory (ROM) 15, a random access memory (RAM) 16, and a processor 17. The communication device 1 is a portable terminal device such as a mobile phone, smartphone, media player, tablet personal computer, or portable game machine for example. The display unit 11 is a thin display device with low power consumption based on a liquid crystal, organic electro luminescence (EL), or the like for example. The touch panel 12 is disposed on the display unit 11 and detects touch operation by a user by using a resistive film system, a capacitive system, or the like for example.

The imaging sensor 13 is a sensor using an imaging element such as a charge coupled device (CCD) or a complementary metal oxide semiconductor (CMOS) for example. The imaging sensor 13 is disposed on the display screen side of the display unit 11 and takes an image of a subject. The grasp sensor 14 is equivalent to e.g. a capacitive sensor or an optical sensor and is a sensor that detects a side of the main body of the communication device 1 (hereinafter, referred to simply as the device main body) grasped by the user. The ROM 15 and the RAM 16 are regions to store various kinds of information. The processor 17 controls the whole of the communication device 1.

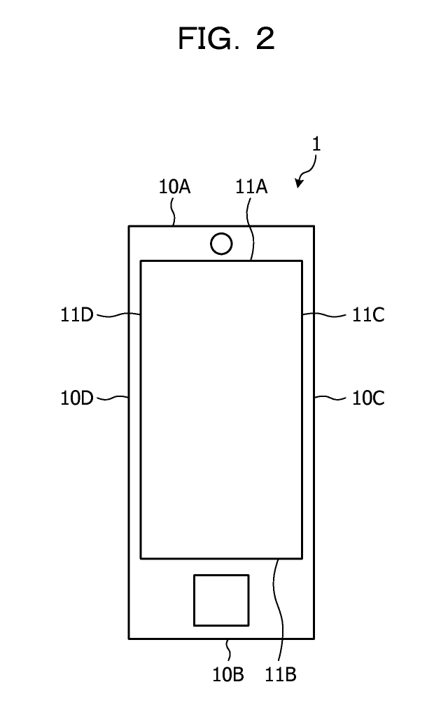

FIG. 2 is a front view of a communication device. The communication device illustrated in FIG. 2 may be the communication device 1 illustrated in FIG. 1. The front face of the communication device 1 illustrated in FIG. 2 is employed as the basis and the respective sides of the communication device 1 are defined as an upper side 10A, a lower side 10B, a right side 10C, and a left side 10D as relative positions. Moreover, the front face of the display screen of the display unit 11 of the communication device 1 is also employed as the basis and the respective sides of the display screen are defined as an upper side 11A, a lower side 11B, a right side 11C, and a left side 11D of the display screen as relative positions.

The processor 17 reads out a screen control program stored in the ROM 15 and configures various kinds of processes as functions on the basis of the read screen control program. The processor 17 includes a recognizing section 21, a determining section 22, a first deciding section 23, a second deciding section 24, and a control section 25.

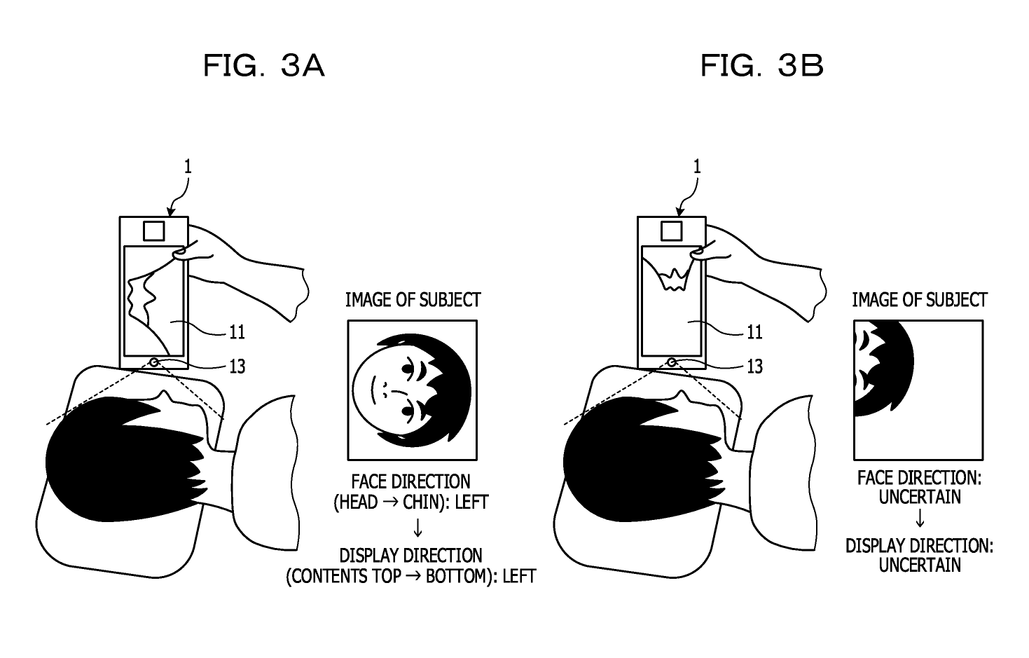

FIGS. 3A and 3B are explanatory diagrams illustrating one example of an operation of a communication device when a face direction of a user is recognized. The communication device illustrated in FIGS. 3A and 3B may be the communication device 1 illustrated in FIG. 1. The recognizing section 21 extracts regions of a human flesh color from an image of a subject acquired by the imaging sensor 13. For example, the recognizing section 21 checks feature patterns of e.g. eye, nose, mouth, etc. with standard patterns and extracts the regions of the human flesh color on the basis of the check result. Moreover, the recognizing section 21 extracts the region of the frontal face from the extracted regions of the human flesh color and recognizes the chin direction from the head of the user to the chin thereof from the extracted region of the frontal face. Then, the recognizing section 21 recognizes the face direction of the user from the extracted chin direction of the user. The recognizing section 21 measures a check distance value of the face image and a check distance value of the positional relationship when the feature patterns of e.g. eye, nose, mouth, etc. are checked, and acquires the accuracy of the face direction recognition on the basis of the measurement result.

The determining section 22 determines whether or not the recognition of the face direction of the user has failed on the basis of the accuracy acquired in the recognizing section 21. For example, if the accuracy is lower than a first threshold, the determining section 22 determines that the recognition of the face direction has failed as illustrated in FIG. 3B because of insufficiency of the check of the face image of the user. Furthermore, if the accuracy is equal to or higher than the first threshold, the determining section 22 determines that the recognition of the face direction has not failed as illustrated in FIG. 3A because of sufficiency of the check of the face image of the user.

The first deciding section 23 decides the face direction of the user if the recognition of the face direction of the user does not fail, i.e. the recognition succeeds. The first deciding section 23 decides the face direction of the user on the basis of the chin direction from the head to the chin. For example, the first deciding section 23 decides that the face direction is the left direction if the chin direction is the left direction, and decides that the face direction is the right direction if the chin direction is the right direction. Moreover, the first deciding section 23 decides that the face direction is the downward direction if the chin direction is the downward direction for example, and decides that the face direction is the upward direction if the chin direction is the upward direction for example.

The control section 25 sets the screen direction of the display screen of the display unit 11 on the basis of the face direction decided in the first deciding section 23. When setting the screen direction, the control section 25 controls the coordinates of the screen. For example if the face direction is the left direction, the control section 25 sets the display screen to the screen direction with which the right side 11C of the display screen is the top side and the left side 11D is the bottom side. Furthermore, for example if the face direction is the right direction, the control section 25 sets the display screen to the screen direction with which the left side 11D of the display screen is the top side and the right side 11C is the bottom side. In addition, for example if the face direction is the upward direction, the control section 25 sets the display screen to the screen direction with which the lower side 11B of the display screen is the top side and the upper side 11A is the bottom side. Moreover, for example if the face direction is the downward direction, the control section 25 sets the display screen to the screen direction with which the upper side 11A of the display screen is the top side and the lower side 11B is the bottom side.

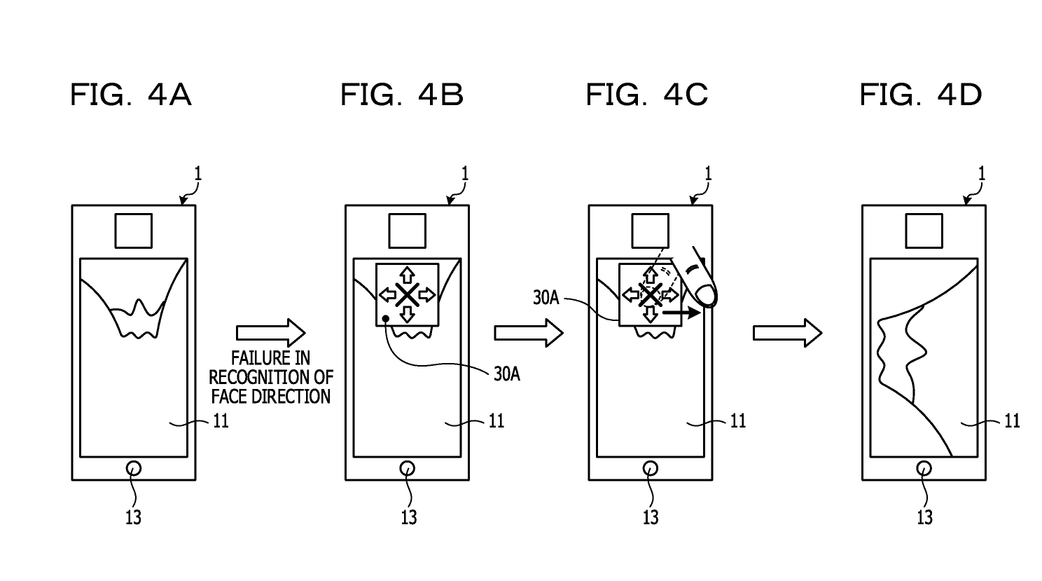

FIGS. 4A, 4B, 4C, and 4D are explanatory diagrams illustrating one example of a specifying operation screen at a time of failure in a face direction recognition. The second deciding section 24 makes transition to an indicating mode if it is determined in the determining section 22 that the recognition of the face direction of the user has failed as illustrated in FIG. 4A. The indicating mode is a mode in which specifying operation of an indication direction is accepted by the specifying operation screen when the recognition of the face direction fails. Upon the transition to the indicating mode, the second deciding section 24 displays a specifying operation screen 30A on the display screen as illustrated in FIG. 4B. Moreover, the control section 25 outputs a notification of the recognition failure to the user by e.g. an alarm sound, pop-up displaying, a vibrator, etc. The specifying operation screen 30A is a screen that accepts specifying operation (e.g. drag operation) to arrows by which an indication direction of the display screen intended by the user is specified. When specifying operation to specify an indication direction on the specifying operation screen 30A as illustrated in FIG. 4C is detected, the second deciding section 24 decides the indication direction specified by the specifying operation.

After the specifying operation screen 30A is displayed, the control section 25 starts count operation of a given-time timer. After the elapse of a given time from the start of the count operation of the given-time timer, the second deciding section 24 deletes the specifying operation screen 30A from the display screen and releases the indicating mode. Furthermore, if operation other than operation to the specifying operation screen 30A is detected after the specifying operation screen 30A is displayed, the second deciding section 24 deletes the specifying operation screen 30A from the display screen and releases the indicating mode. As a result, the user can alleviate the burden of operation for the deletion of the specifying operation screen 30A and the release of the indicating mode when switching of the screen direction of the display screen is unnecessary.

When specifying operation of an indication direction is detected on the specifying operation screen 30A as illustrated in FIG. 4C, the second deciding section 24 specifies the indication direction on the basis of specifying operation in an arrow direction of the specifying operation screen 30A. The control section 25 sets the screen direction of the display unit 11 to the indication direction decided in the second deciding section 24 as illustrated in FIG. 4D. That is, if the decided indication direction is the right direction, the control section 25 sets the display screen to the screen direction with which the left side 11D of the display screen is the top side and the right side 11C is the bottom side. Furthermore, if the decided indication direction is the left direction, the control section 25 sets the display screen to the screen direction with which the right side 11C of the display screen is the top side and the left side 11D is the bottom side. If the decided indication direction is the upward direction, the control section 25 sets the display screen to the screen direction with which the lower side 11B of the display screen is the top side and the upper side 11A is the bottom side. If the decided indication direction is the downward direction, the control section 25 sets the display screen to the screen direction with which the upper side 11A of the display screen is the top side and the lower side 11B is the bottom side.

The grasp sensor 14 recognizes the sides 10A, 10B, 10C, and 10D of the device main body grasped by the user. The second deciding section 24 displays the specifying operation screen 30A in a display region of the display unit 11 near the side recognized by the grasp sensor 14. For example, if it is recognized that the upper side 10A of the device main body is grasped, the second deciding section 24 displays the specifying operation screen 30A in a display region near the upper side 10A. If it is recognized that the lower side 10B of the device main body is grasped, the second deciding section 24 displays the specifying operation screen 30A in a display region near the lower side 10B. If it is recognized that the right side 10C of the device main body is grasped, the second deciding section 24 displays the specifying operation screen 30A in a display region near the right side 10C. If it is recognized that the left side 10D of the device main body is grasped, the second deciding section 24 displays the specifying operation screen 30A in a display region near the left side 10D. As a result, the user can ensure the operability of the specifying operation screen 30A because the specifying operation screen 30A is displayed near the grasping hand with which the user grasps the device main body.

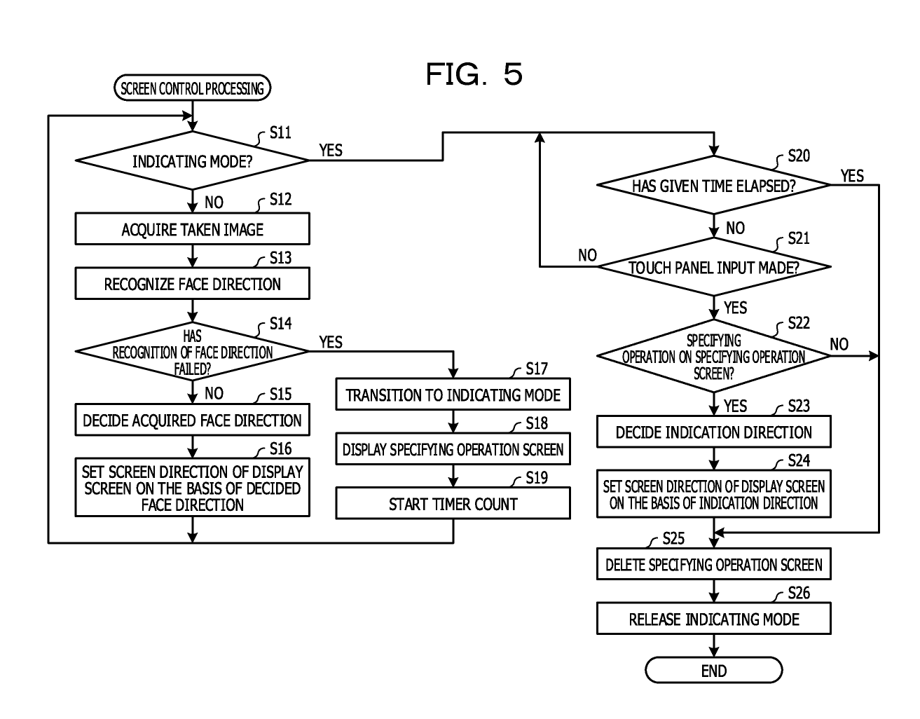

Next, the operation of the communication device 1 of the first embodiment will be described. FIG. 5 is a flowchart illustrating one example of a processing operation of a processor of a communication device relating to screen control processing. The processor and the communication device described with reference to FIG. 5 may be respectively the processor and the communication device illustrated in FIG. 1. The screen control processing illustrated in FIG. 5 is processing of displaying the specifying operation screen if recognition of the face direction fails and setting the screen direction of the display screen to an indication direction specified according to specifying operation of the indication direction on the specifying operation screen.

In FIG. 5, the control section 25 in the processor 17 determines whether or not the present mode is the indicating mode (step S11). If the present mode is not the indicating mode (No in step S11), the recognizing section 21 in the processor 17 acquires the present taken image through the imaging sensor 13 (step S12). The recognizing section 21 recognizes the face direction of a user from the acquired taken image (step S13).

The determining section 22 in the processor 17 determines whether or not the recognition of the face direction has failed in the recognizing section 21 (step S14). If the recognition of the face direction has not failed (No in step S14), i.e. if the recognition of the face direction has succeeded, the first deciding section 23 in the processor 17 decides the face direction of the user (step S15). The control section 25 sets the screen direction of the display screen on the basis of the face direction of the user decided in the first deciding section 23 (step S16).

If the recognition of the face direction has failed (Yes in step S14), the second deciding section 24 makes transition to the indicating mode (step S17) and displays the specifying operation screen 30A in a display region near a side as a sensor result of the grasp sensor 14 (step S18). After the specifying operation screen 30A is displayed, the control section 25 starts the count operation of the given-time timer (step S19) and makes transition to step S11 in order to determine whether or not the present mode is the indicating mode.

If the present mode is the indicating mode (Yes in step S11), the control section 25 determines whether or not the given time has elapsed in the given-time timer (step S20). If the given time has not elapsed (No in step S20), the control section 25 determines whether or not an input on the touch panel 12 is made (step S21). If an input on the touch panel 12 is made (Yes in step S21), the control section 25 determines whether or not specifying operation on the specifying operation screen 30A is detected (step S22). If specifying operation on the specifying operation screen 30A is detected (Yes in step S22), the second deciding section 24 decides the indication direction of the specifying operation (step S23). The control section 25 sets the screen direction of the display screen on the basis of the indication direction decided in the second deciding section 24 (step S24). After the screen direction of the display screen is set, the second deciding section 24 deletes the specifying operation screen 30A (step S25) and releases the indicating mode (step S26) to end the processing operation illustrated in FIG. 5. If the given time has elapsed (Yes in step S20), the second deciding section 24 makes transition to step S25 in order to delete the specifying operation screen 30A. If an input on the touch panel 12 is not made (No in step S21), the control section 25 makes transition to step S20 in order to determine whether or not the given time has elapsed.

The processor 17 that executes the screen control processing illustrated in FIG. 5 displays the specifying operation screen 30A on the screen if recognition of the face direction fails. Then, the processor 17 specifies an indication direction on the specifying operation screen 30A and sets the screen direction of the display screen to the specified indication direction. As a result, the user can set the screen direction of the display screen to the indication direction intended by the user oneself.

The processor 17 starts the count operation of the given-time timer after displaying the specifying operation screen 30A, and carries out the deletion of the specifying operation screen 30A and the release of the indicating mode if the given time elapses. As a result, the user can alleviate the burden of operation for the deletion of the specifying operation screen 30A and the release of the indicating mode.

After the specifying operation screen 30A is displayed, if operation to the touch panel 12 other than operation to the specifying operation screen 30A is detected, the processor 17 carries out the deletion of the specifying operation screen 30A and the release of the indicating mode even before the elapse of the given time. As a result, the user can alleviate the burden of operation for the deletion of the specifying operation screen 30A and the release of the indicating mode.

If recognition of the face direction fails, the communication device 1 of the first embodiment specifies an indication direction on the basis of given operation and sets the screen direction of the display screen to the specified indication direction. As a result, the user can avoid setting of the display screen to an unintended screen direction and set the display screen to the intended screen direction.

The communication device 1 displays the specifying operation screen 30A if recognition of the face direction fails, and specifies an indication direction on the basis of operation by the user on the specifying operation screen 30A. As a result, the user can avoid setting of the display screen to an unintended screen direction.

The communication device 1 displays the specifying operation screen 30A on the screen in a display region near a grasped side detected by the grasp sensor 14 if recognition of the face direction fails. As a result, the user can ensure the operability of the specifying operation screen 30A.

After the specifying operation screen 30A is displayed, the communication device 1 deletes the specifying operation screen 30A from the display screen after the elapse of the given time. As a result, the specifying operation screen 30A can be automatically deleted after the elapse of the given time and thus the user can alleviate the burden of operation for the deletion.

If detecting touch operation to a display region other than the specifying operation screen 30A while the specifying operation screen 30A is displayed, the communication device 1 deletes the specifying operation screen 30A. As a result, the user can alleviate the burden of operation in the deletion of the specifying operation screen 30A when the screen direction does not need to be changed.

In the above-described first embodiment, an indication direction is specified by drag operation with an arrow on the specifying operation screen 30A. However, the indication direction may be specified by button operation with a physical button.

In the above-described first embodiment, the specifying operation screen 30A is displayed in a display region near a grasp position detected by the grasp sensor 14. However, without using the grasp sensor 14, the specifying operation screen 30A may be displayed near an end of a long side of the display screen of the communication device 1, e.g. the right side 11C or the left side 11D.

The display unit 11 of the above-described first embodiment displays the specifying operation screen 30A on the display screen. The display unit 11 may display the specifying operation screen 30A in a semitransparent state. As a result, the displayed contents are not hidden by the displaying of the specifying operation screen 30A and the user can visually recognize the displayed contents.

Furthermore, an indication direction on the specifying operation screen 30A may be specified on the basis of the tilt direction of the device main body. An embodiment of this case will be described below as a second embodiment.

### Second Embodiment

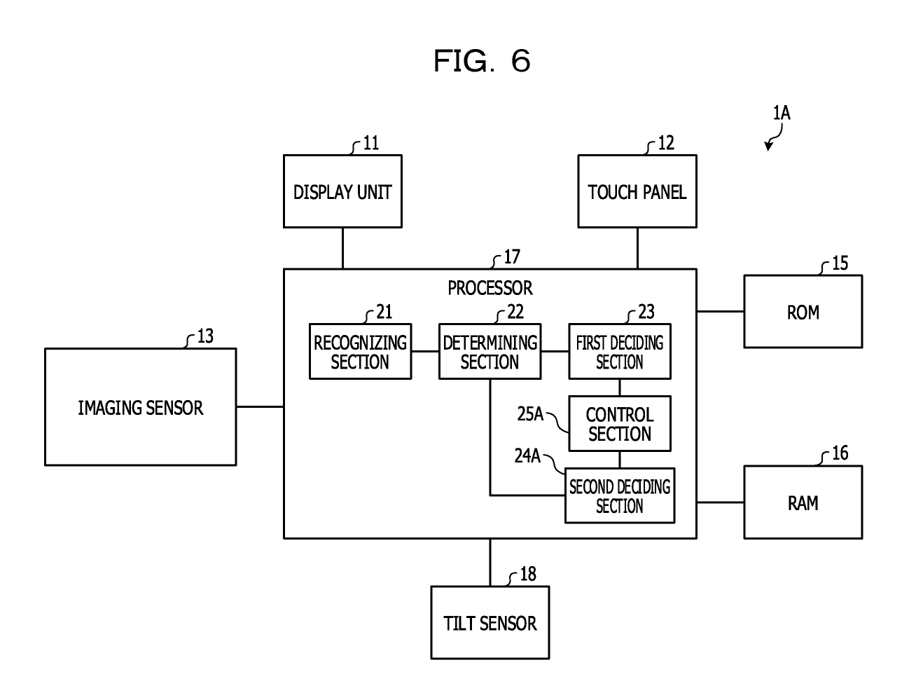

FIG. 6 is a block diagram illustrating one example of a communication device of a second embodiment. The same configurations as the configurations in the communication device 1 of the first embodiment are given the same numerals and thereby description of the overlapping configurations and operation is omitted.

The difference of a communication device 1A illustrated in FIG. 6 from the communication device 1 illustrated in FIG. 1 is that the amount of tilt at a first timing at which recognition of the face direction fails is employed as the basis and thereafter the tilt direction of the device main body is specified as an indication direction from the amount of tilt change derived from the detected amount of tilt of the device main body. The first timing is e.g. a timing when it is determined in the determining section 22 that recognition of the face direction has failed and transition to the indicating mode is made and the amount of tilt of the device main body in the gravitational direction, detected by a tilt sensor 18, is equal to or smaller than a given level, i.e. the device main body is in the still state.

The tilt sensor 18 is equivalent to e.g. an acceleration sensor or an orientation sensor and detects the amount of tilt of the device main body. A second deciding section 24A displays a mark of failure in face direction recognition on the display screen of the display unit 11 if the amount of tilt of the device main body in the gravitational direction is equal to or smaller than the given level after transition to the indicating mode.

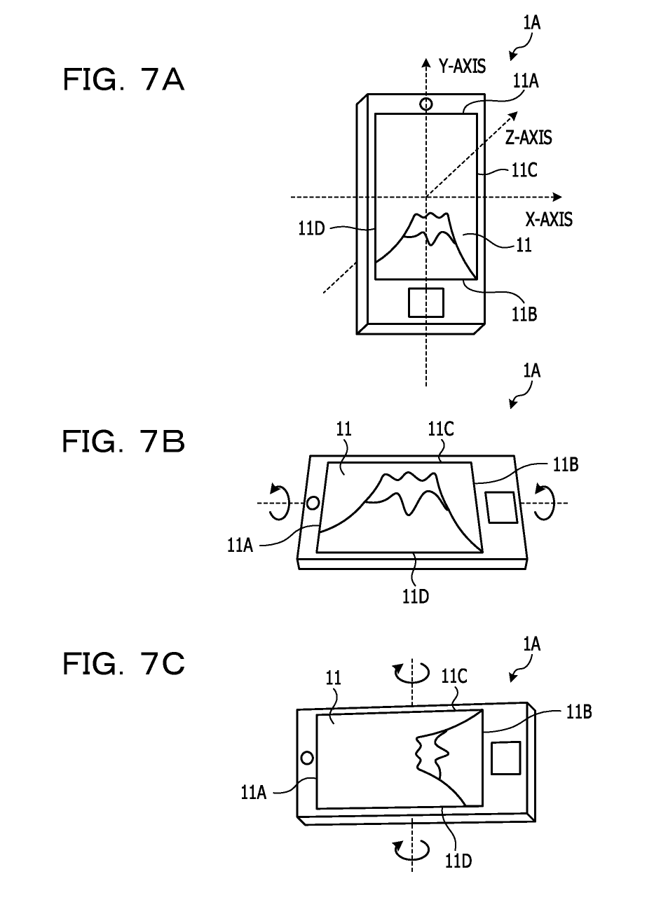

FIGS. 7A, 7B, and 7C are explanatory diagrams illustrating one example of a specifying operation to specify an indication direction from a tilt direction. In the communication device 1A illustrated in FIG. 7A, the left-right direction, the upward-downward direction, and the front-back direction of the flat surface are defined as the x-axis, the y-axis, and the z-axis, respectively, and the gravitational direction is expressed by a vector (x, y, z). A control section 25A acquires the vector of the gravitational direction at the first timing through the tilt sensor 18 and stores this vector in the RAM 16 as a reference vector.

After the reference vector is stored, when detecting the amount of tilt of the device main body through the tilt sensor 18, the second deciding section 24A acquires the present amount of tilt of the device main body acquired by the tilt sensor 18, i.e. the present vector of the gravitational direction. Moreover, the second deciding section 24A calculates the inner product of the present vector and the reference vector and calculates the amount of tilt change on the basis of the calculated inner product. Then, if the calculated amount of tilt change surpasses a given amount of change, the second deciding section 24A decides the tilt direction as the indication direction.

The control section 25A sets the screen direction of the display screen to the indication direction decided in the second deciding section 24A. If the z-axis is tilted toward the side of the right side 11C of the display screen as illustrated in FIG. 7B with an amount of tilt change surpassing the given amount of change, the control section 25A specifies this tilt direction as the indication direction and sets the display screen to the screen direction with which the right side 11C is the top side and the left side 11D is the bottom side. If the z-axis is tilted toward the side of the left side 11D of the display screen with an amount of tilt change surpassing the given amount of change, the control section 25A sets the display screen to the screen direction with which the left side 11D is the top side and the right side 11C is the bottom side.

Furthermore, if the z-axis is tilted toward the side of the upper side 11A of the display screen as illustrated in FIG. 7C with an amount of tilt change surpassing the given amount of change, the control section 25A sets the display screen to the screen direction with which the upper side 11A is the top side and the lower side 11B is the bottom side. If the z-axis is tilted toward the side of the lower side 11B of the display screen with an amount of tilt change surpassing the given amount of change, the control section 25A sets the display screen to the screen direction with which the lower side 11B is the top side and the upper side 11A is the bottom side.

In the communication device 1A of the second embodiment, if recognition of the face direction fails, an indication direction is specified on the basis of a tilt direction by tilt operation of the device main body and the screen direction of the display screen is set to the specified indication direction. As a result, the user can set the display screen to the intended screen direction by the tilt operation of the device main body.

The case in which the control section 25 of the above-described first embodiment specifies an indication direction through specifying operation on the specifying operation screen 30A is exemplified. However, for example, the indication direction may be specified on the basis of a swing direction of the device main body. An embodiment of this case will be described below as a third embodiment.

### Third Embodiment

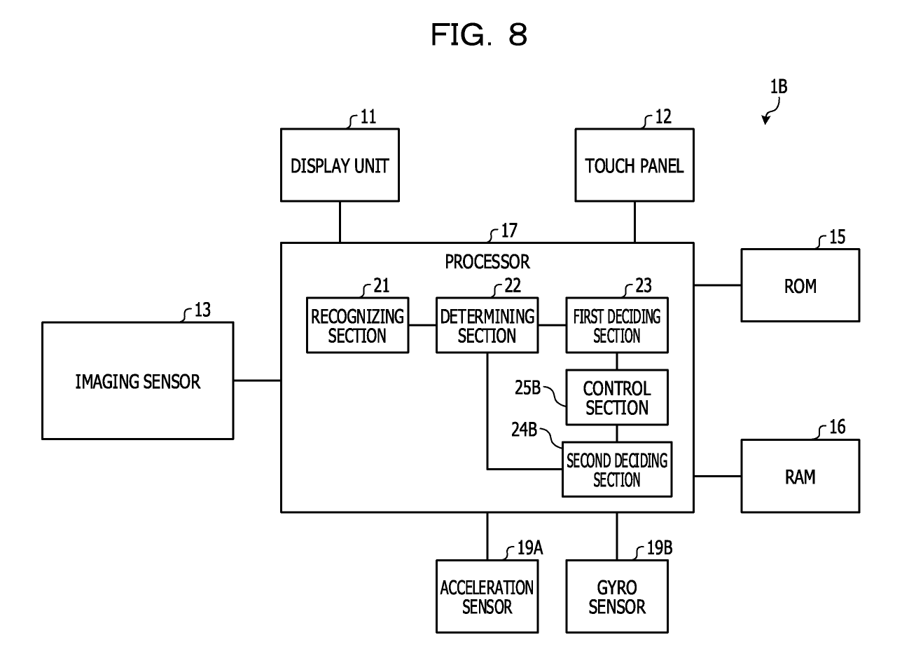

FIG. 8 is a block diagram illustrating one example of a communication device of a third embodiment. The same configurations as the configurations in the communication device 1 of the first embodiment are given the same numerals and thus the description of the overlapping configurations and operation is omitted.

The difference of the communication device 1B illustrated in FIG. 8 from the communication device 1 illustrated in FIG. 1 is that the positional relationship between the position of the device main body and the position of the axis of the swing of the device main body is calculated from the acceleration of the device main body and the grasp position is estimated from the calculated positional relationship to specify an indication direction from the grasp position. The communication device 1B includes an acceleration sensor 19A that detects the acceleration of the device main body and a gyro sensor 19B.

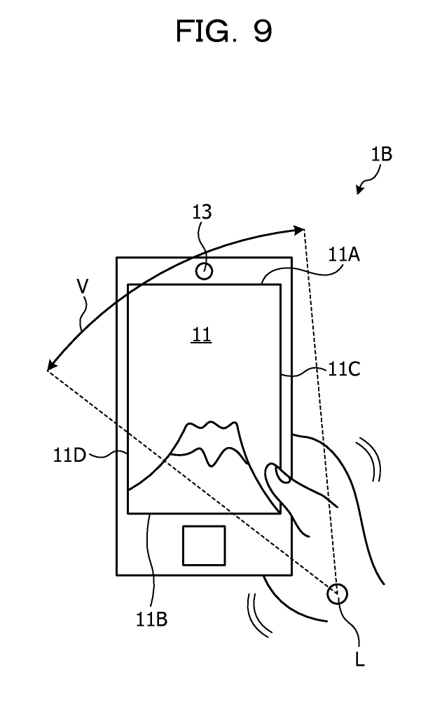

FIG. 9 is an explanatory diagram illustrating one example of a specifying operation to specify an indication direction from a swing direction. In FIG. 9, the specifying operation of the indication direction by a user is operation of specifying the grasp position by operation of swinging the device main body, with the wrist of a hand grasping the device main body being an axis L, and specifying the indication direction from the grasp position after recognition of the face direction fails and transition to the indicating mode is made. A control section 25B recognizes the grasping hand of the user with which the device main body is grasped.

A second deciding section 24B removes the gravitational component from an acceleration value of the device main body by the acceleration sensor 19A and performs double integration. Then, the second deciding section 24B corrects the resulting value by an actual measurement value of the gyro sensor 19B to calculate a movement vector V of the device main body. The second deciding section 24B applies the trajectory of the calculated movement vector V of the device main body to circular motion by the least squares method or the like and estimates the radius and the position of the center axis L from the circular motion. Then, the second deciding section 24B estimates how the device main body is held, i.e. the grasp position of the device main body, from the estimated position of the center axis L.

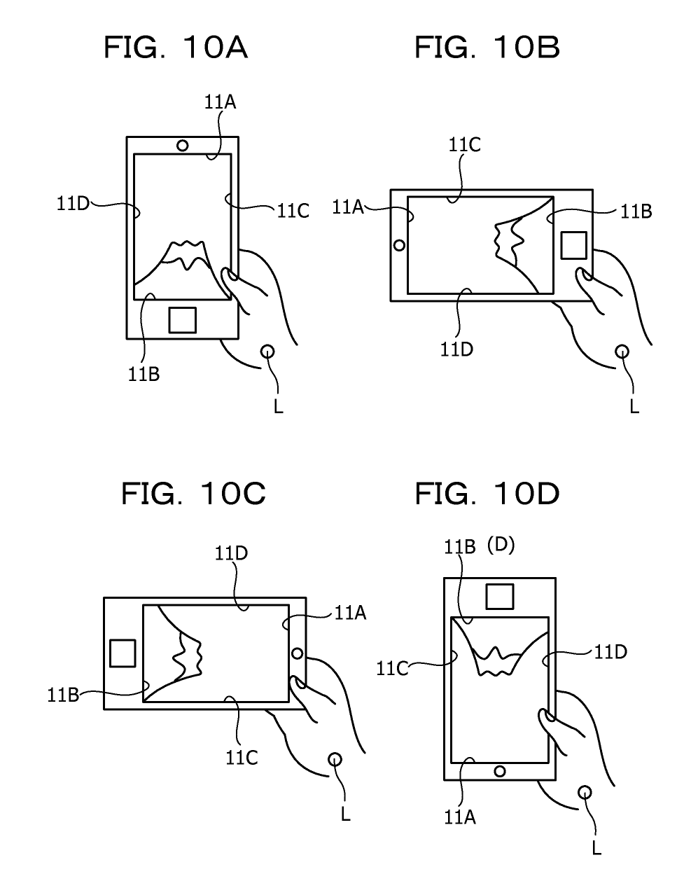

FIGS. 10A, 10B, 10C, and 10D are explanatory diagrams illustrating one example of an estimated grasp position. For convenience of explanation, suppose that the user's grasping hand of the device main body is the right hand. If the center axis L exists on the lower right side of the device main body as illustrated in FIG. 10A, the second deciding section 24B estimates a grasp position at which the device main body is longitudinally grasped, with the upper side 11A of the display screen being the top side and the lower side 11B being the bottom side. If the center axis L exists on the lower left side of the device main body as illustrated in FIG. 10B, the second deciding section 24B estimates a grasp position at which the device main body is laterally grasped, with the left side 11D of the display screen being the bottom side and the right side 11C being the top side. If the center axis L exists on the upper right side of the device main body as illustrated in FIG. 10C, the second deciding section 24B estimates a grasp position at which the device main body is laterally grasped, with the right side 11C of the display screen being the bottom side and the left side 11D being the top side. If the center axis L exists on the upper left side of the device main body as illustrated in FIG. 10D, the second deciding section 24B estimates a grasp position at which the device main body is longitudinally grasped, with the upper side 11A of the display screen being the bottom side and the lower side 11B being the top side.

The control section 25B sets the screen direction of the display screen on the basis of the grasp position estimated in the second deciding section 24B. For example, if the grasp position exists on the lower right side of the device main body, the control section 25B sets the display screen to the screen direction with which the upper side 11A is the top side and the lower side 11B is the bottom side. If the grasp position exists on the lower left side of the device main body, the control section 25B sets the display screen to the screen direction with which the right side 11C is the top side and the left side 11D is the bottom side. Furthermore, if the grasp position exists on the upper right side of the device main body, the control section 25B sets the display screen to the screen direction with which the left side 11D is the top side and the right side 11C is the bottom side. Moreover, if the grasp position exists on the upper left side of the device main body, the control section 25B sets the display screen to the screen direction with which the lower side 11B is the top side and the upper side 11A is the bottom side.

In the communication device 1B of the third embodiment, if recognition of the face direction fails, the grasp position is estimated on the basis of a movement vector by swing operation of the device main body. Then, an indication direction is specified on the basis of the estimated grasp position and the screen direction of the display screen is set to the specified indication direction. As a result, the user can set the display screen to the intended screen direction by the swing operation of the device main body.

Furthermore, the respective constituent elements of the respective units illustrated in the drawings do not necessarily need be configured as illustrated in the drawings physically. For example, specific forms of distribution and integration of the respective units are not limited to the illustrated ones and all or part of the respective units can be configured to be distributed and integrated functionally or physically in an arbitrary unit according to various kinds of loads, the status of use, and so forth.

Moreover, all or an arbitrary part of various kinds of processing functions carried out in the respective devices may be carried out on a central processing unit (CPU) (or a microcomputer such as a micro processing unit (MPU) or a micro controller unit (MCU)). Furthermore, it goes without saying that all or an arbitrary part of the various kinds of processing functions may be carried out on a program analyzed and executed by a CPU (or a microcomputer such as an MPU or an MCU) or on hardware based on wired logic.

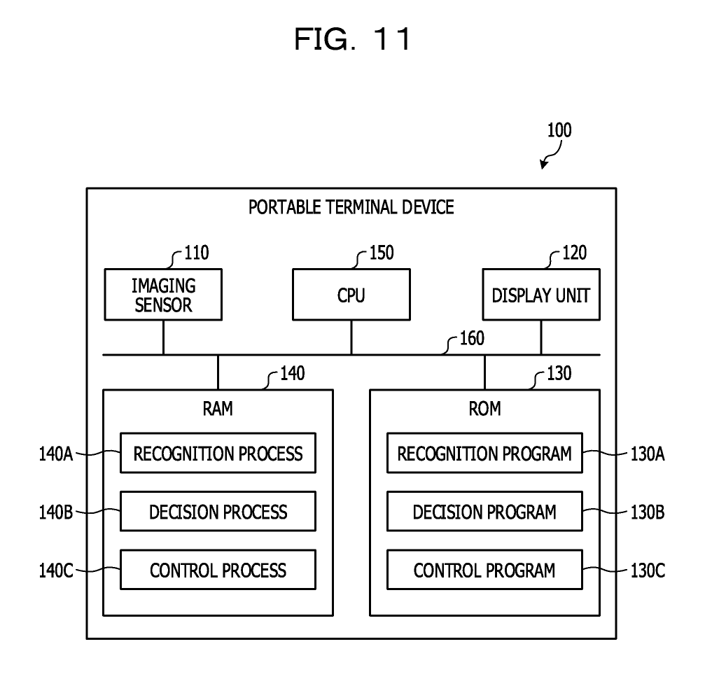

By the way, various kinds of processing described in the embodiments can be implemented through execution of programs prepared in advance by a processor such as a CPU in the communication device. Thus, in the following, one example of the communication device that executes programs having functions similar to the functions in the above-described embodiments will be described. FIG. 11 is an explanatory diagram illustrating one example of a communication device that executes screen control programs.

A communication device 100 that executes the screen control programs illustrated in FIG. 11 includes an imaging sensor 110, a display unit 120, a ROM 130, a RAM 140, and a CPU 150. The imaging sensor 110, the display unit 120, the ROM 130, the RAM 140, and the CPU 150 are coupled via a bus 160. The imaging sensor 110 takes an image of a subject. The display unit 120 displays a display screen.

Furthermore, the screen control programs that exert functions similar to the functions in the above-described embodiments are stored in the ROM 130 in advance. In the ROM 130, a recognition program 130A, a decision program 130B, and a control program 130C are stored as the screen control programs. The screen control programs may be recorded in not the ROM 130 but a recording medium that can be read by a computer through a drive (not illustrated). Furthermore, as the recording medium, e.g. a portable recording medium such as a compact disc-ROM (CD-ROM), a digital versatile disc (DVD), or a universal serial bus (USB) memory, a semiconductor memory such as a flash memory, or the like may be used.

Furthermore, the CPU 150 reads out the recognition program 130A from the ROM 130 and functions as a recognition process 140A on the RAM 140. Moreover, the CPU 150 reads out the decision program 130B from the ROM 130 and functions as a decision process 140B on the RAM 140. The CPU 150 reads out the control program 130C from the ROM 130 and functions as a control process 140C on the RAM 140.

The CPU 150 in the communication device 100 recognizes the face direction of a user from a taken image obtained by imaging. If the recognition of the face direction fails, the CPU 150 decides an indication direction on the basis of given operation. The CPU 150 sets the screen direction of the display screen to the decided indication direction. As a result, the display screen can be set to the screen direction intended by the user.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A screen control method executed by a computer, the screen control method comprising:
acquiring an image;
executing recognition processing to specify a first direction from a top of a head to a chin in a face region of a user extracted from the image when the face region is detected;
when the first direction is not specified in the recognition processing, determining a second direction based on given operation by the user; and
setting a display direction of a screen displayed on a display based on the second direction.

2. The screen control method according to claim 1, further comprising:
displaying an operation screen by which the second direction is specified on the display when the first direction is not specified in the recognition processing; and
accepting the given operation to specify the second direction on the operation screen.

3. The screen control method according to claim 2, further comprising:
detecting a position of a grasp of the computer including the display by the user, and
wherein the operation screen is displayed near the position of the grasp on the display.

4. The screen control method according to claim 2, wherein the operation screen is displayed near a short side of the display.

5. The screen control method according to claim 2, wherein the operation screen is displayed in a semitransparent state.

6. The screen control method according to claim 2, further comprising:
ending displaying of the operation screen after elapse of a given time from the displaying of the operation screen.

7. The screen control method according to claim 1, further comprising:
detecting a first tilt of the computer including the display at a first timing;
detecting a second tilt of the computer at a second timing later than the first timing; and
determining the second direction based on an amount of change from the first tilt to the second tilt when the first direction is not specified in the recognition processing.

8. The screen control method according to claim 1, further comprising:
detecting acceleration of the computer including the display at a given time interval;
specifying a movement trajectory of the computer based on the acceleration;
calculating a positional relationship between a present position of the computer and a position of an axis of a swing of the computer based on the movement trajectory;
estimating a grasp position of the computer from the positional relationship; and
determining the second direction based on the grasp position.

9. The screen control method according to claim 1, further comprising:
setting the display direction of the screen displayed on the display based on the first direction when the first direction is specified in the recognition processing.

10. A non-transitory storage medium storing a screen control program which causes a computer to execute a procedure, the procedure comprising:
acquiring an image;
executing recognition processing to specify a first direction from a top of a head to a chin in a face region of a user extracted from the image when the face region is detected;
when the first direction is not specified in the recognition processing, determining a second direction based on given operation by the user; and
setting a display direction of a screen displayed on a display based on the second direction.

11. A communication device comprising:
a memory; and
a processor coupled to the memory and configured to:
acquire an image,
execute recognition processing to specify a first direction from a top of a head to a chin in a face region of a user extracted from the image when the face region is detected,
when the first direction is not specified in the recognition processing, determine a second direction based on given operation by the user, and
set a display direction of a screen displayed on a display based on the second direction.

12. The communication device according to claim 11, wherein the processor is configured to:
display an operation screen by which the second direction is specified on the display when the first direction is not specified in the recognition processing, and
accept the given operation to specify the second direction on the operation screen.

13. The communication device according to claim 12, wherein
the processor is configured to detect a position of a grasp of the computer including the display by the user, and
the operation screen is displayed near the position of the grasp on the display.

14. The communication device according to claim 12, wherein the operation screen is displayed near a short side of the display.

15. The communication device according to claim 12, wherein the operation screen is displayed in a semitransparent state.

16. The communication device according to claim 12, wherein the processor is configured to end displaying of the operation screen after elapse of a given time from the displaying of the operation screen.

17. The communication device according to claim 11, wherein the processor is configured to:
detect a first tilt of the computer including the display at a first timing,
detect a second tilt of the computer at a second timing later than the first timing, and
determine the second direction based on an amount of change from the first tilt to the second tilt when the first direction is not specified in the recognition processing.

18. The communication device according to claim 11, wherein the processor is configured to:
detect acceleration of the computer including the display at a given time interval,
specify a movement trajectory of the computer based on the acceleration,
calculate a positional relationship between a present position of the computer and a position of an axis of a swing of the computer based on the movement trajectory,
estimate a grasp position of the computer from the positional relationship, and
determine the second direction based on the grasp position.

19. The communication device according to claim 11, wherein the processor is configured to set the display direction of the screen displayed on the display based on the first direction when the first direction is specified in the recognition processing.
